(19) United States
(12) Patent Application Publication
(10) Pub. No.: US 2016/0035472 A1
(43) Pub. Date: Feb. 4, 2016

(54) Electromagnetic Energy Device with Improved Coil and Method of Use

(71) Applicant: Ricky Venoie Draper, Denton, TX (US)

(72) Inventor: Ricky Venoie Draper, Denton, TX (US)

(21) Appl. No.: 14/447,814

(22) Filed: Jul. 31, 2014

(51) Int. Cl. H01F 7/06; H01F 7/126; H01F 27/28; H01F 27/24; H01F 27/32; H01F 27/29; H01F 7/08; H01F 1/12

(52) U.S. Cl. CPC H01F 7/064; H01F 7/081; H01F 7/126; H01F 1/12; H01F 27/24; H01F 27/327; H01F 27/29; H01F 27/28; H01F 2007/062; H01F 2007/086

(57) ABSTRACT

An apparatus and method are shown for improving the efficiency of motors, generators and machines by using a closed ferromagnetic frame upon which is mounted a plurality of solenoid coils. Two of the solenoid coils are wired together so that they act as one in a closed wiring circuit. An armature assembly includes a carousel which carries electromagnetic coils and is rotated through an opening provided in an extension to the closed frame. The individual electromagnetic coils located on the carousel are associated with the two original solenoid coils on the ferromagnetic frame giving the basic circulation system amplification each time a coil enters the electric/magnetic field created by the frame uprights. A magnetic output can be obtained from a third solenoid coil located on the closed frame.

### BACKGROUND OF THE INVENTION

1. Field of the Invention

This invention relates to the field of electromagnetic devices such as motors, generators and machines and to methods for improving the efficiency thereof and more particularly to a high-efficiency electromagnetic coil having a large number of applications for such devices.

2. Description of the Prior Art

The present invention has its basis in known laws relating to physics, magnetism and kinetic energy. It is generally understood that moving electrons like other moving matter contain kinetic energy. For example, electrons moving from negative to positive electrodes contain kinetic energy. Similarly, electrons moving between magnetic poles contain kinetic energy.

As electrons move from a negative electrode to a positive electrode, they create a current. A moving electron also creates a magnetic field around itself. The direction of the magnetic field is sometimes explained for simplicity in terms of the “right hand rule.” In electromagnetism, the right-hand rule can be used to determine the direction of the magnetic field produced by a rotating electric charge. This is done by first curling a person's right hand in the direction of the rotating current. When this is done, then the thumb on the right hand points in the direction of the resulting magnetic north pole. The magnetic field will also have an oppositely arranged south pole. A magnetic pole attracts a pole of opposite magnetic polarity. Conversely, two like magnetic poles repel each other.

Traditional generators capture the flow of electrons created by induction when a magnet is moved relative to a coil. A magnet having two poles, one magnetically north and the other magnetically south, is aligned so that one pole is facing the coil with the other, opposite pole, facing away from the coil. As the magnet is brought nearer the coil, the approaching magnetic field increases flux in the coil, which induces an electrical current that tends to oppose the change in flux in the coil. The direction of the current reverses as the magnet passes the center of the coil as the north pole moves away from the coil. In this particular arrangement, this reversing current is an alternating current. These principles are well understood and are utilized at the present time in the design of reciprocating motors and engines. Rotary designs of generators and motors also rely on the same principles of magnetic induction as reciprocating motors and engines.

A large body of patent art exists which embodies various offshoots of the above described principles of electromagnetism. For example, U.S. Pat. No. 6,169,343, issued Jan. 2, 2001, to Rich, Sr., is typical of a number of prior art reference which discuss the various implications of the magnetic fields which surround current-carrying coils. The Rich, Sr., reference is directed toward improving the efficiency of prior art generators and motors by reducing the counter electromotive forces which are typically present in the prior art devices of the type described above. This patent discloses a piston and coil arrangement that promotes magnetic attraction and repulsion between the coil and the outside poles. The coil is an electromagnet, and when a current is passed through the coil, a magnetic field is created with a magnetic polarity. The motion of the piston and the magnetism are aligned in the particular scheme which is shown in this reference in order to increase the efficiency of the device.

A number of prior art references use “carousel” type components in their physical design. For example, U.S. Pat. No. 5,625,241 teaches a permanent magnet generator having stationary coils positioned in a circle and a carousel carrying corresponding groups of permanent magnets through the centers of the coils. U.S. Pat. No. 5,663,605 is also a rotating electrical machine with electromagnetic and permanent magnet excitation being utilized in the design. U.S. Pat. No. 5,767,601 discloses a device that generates electricity in armature coils by the rotation of permanent magnets placed on a rotor.

U.S. Pat. No. 6,232,690 shows a DC motor having an air gap and a stator coil positioned within the air gap. First and second permanent magnet rotors are coaxially arranged to one another in the housing on opposite sides of the air gap. At least one permanent magnet rotor has an axially magnetized annular rotor magnet.

U.S. Pat. No. 6,515,390 shows a rotor made in the form of two disks. The stator is made in the form of coils that are distributed over the circumference and that are installed predominantly in the space between the rotor poles. They provide for the possibility of an “end face interaction” with the rotor poles. The circumferential array of coils, each being wound about an axis parallel to the shaft, generate an axially directed electromagnetic field that interacts with north and south flux lines.

Additionally, U.S. Pat. No. 6,940,200 is a continuation-in-part of the previously described patent. This electric drive has windings between magnetized disks with a magnetic rotor and at least one stator. The magnetic rotor comprises at least two disks being made from ferromagnetic material and installed on a shaft, and the disks are magnetized in a direction parallel to the shaft. The stator is located between the two magnetized disks and comprises two layers of circumferentially arrayed coil windings etched on both sides of a printed circuit board and a controlling device. Each layer has several pairs of coil windings. One of the coil windings is interrupted for providing power leads to the controlling device.

In U.S. Pat. No. 7,759,809, issued Jul. 20, 2010, to Rick V. Draper, an apparatus and method are shown for improving the efficiency of motors, generators and machines by using a closed ferromagnetic frame upon which is mounted a plurality of solenoid coils. Two of the solenoid coils are wired together so that they act as one in a closed wiring circuit. An associated armature assembly includes a carousel which carries additional solenoid coils and is rotated through an opening provided in an extension to the closed frame. The individual solenoid coils located on the carousel supply power to the two original solenoid coils on the ferromagnetic frame giving the basic circulation system amplification each time a solenoid enters the electric/magnetic field created by the frame uprights.

The present invention has as one object to provide an improved electromagnetic coil for use in various types of motors, generators and machines of the type previously described and, in particular, in a system of the general type described in the above mentioned U.S. Pat. No. 7,759,809.

### SUMMARY OF THE INVENTION

The invention is, in part, an apparatus for generating electromagnetic forces or energy having a magnetic output, the apparatus utilizing an improved electromagnetic coil of novel design. The apparatus preferably utilizes an improved type of electromagnetic coil for generating a magnetic force output. The improved coil has a plurality of helical windings arranged about a central opening. The helical windings terminate in a first magnetic-north, positive lead and a second magnetic-south negative lead. The central opening contains a rod-shaped core material. The core material can be of any substance such as a precious metal, e.g., gold or silver or platinum; or iron, or a crystal substance such as a gem stone or diamond, or even a natural substance such as wood or rock or even water. Most preferably, the rod-shaped core material is a rock core. The rod-shaped, rock core has a given length and a given diameter. A glass insulating cylinder is also located in the central opening of the coil and receives and tightly surrounds the rock core, running for substantially the length of the rock core. The plurality of helical windings can be any convenient type of conductive wire, for example, a high tensile, drawn steel wire.

The previously described improved electromagnetic coil can be incorporated into an apparatus of the type previously described in U.S. Pat. No. 7,759,809. That type apparatus includes, as a primary component, a closed frame formed of a ferromagnetic material. A first solenoid coil having a plurality of windings and a central opening is mounted on the closed frame with the frame passing through the central opening. The first solenoid coil has a first end with a magnetic-north, positive input and an opposed second end with a magnetic-south, negative output when energized. A second solenoid coil having a plurality of windings and a central opening is also mounted on the closed frame with the frame passing through the central opening. The second solenoid coil has a first end with a magnetic-south, negative input and an opposed second end with a magnetic-north, positive output when energized.

The first and second solenoid coils are wired together in a particular way in a special wiring circuit. The input of the first solenoid coil is connected to the output of the second solenoid coil and the input of the second solenoid coil is connected to the output of the first solenoid coil, thereby forming a closed wiring circuit which, in effect, allows the two solenoid coils to act as a single coil.

The apparatus, as described, is initially energized by connecting a source of DC current to the previously described wiring circuit for the first and second solenoid coils. This can be accomplished by using a standard DC battery having a positive terminal and a negative terminal. The input of the first solenoid coil is connected to the positive battery terminal and the output of the first solenoid coil is connected to the negative battery terminal, the second solenoid coil input and output being oppositely wired.

The previously described apparatus will also typically have an output device which is also attached to the closed frame. In one preferred form, the output device is a third solenoid coil having a plurality of windings terminating in a pair of output leads and a central opening, the third solenoid coil being mounted on the closed frame with the frame passing through the central opening.

In order to magnify the magnetic forces which can be extracted from the third solenoid coil, an armature assembly is operatively associated with the closed frame and first, second and third solenoid coils. For example, the particular armature assembly employed can comprise a pair of uprights connected to the closed ferromagnetic frame and separated by an opening therebetween. A carousel is arranged to pass through the opening between the uprights, the carousel having a plurality of additional electromagnetic coils mounted thereon at least selected ones of which are of the novel design described above. The coils mounted on the carousel each have a contact lead or surface which is arranged to contact a mating contact lead or surface which is connected to the first and second solenoid coils mounted on the closed frame. As the carousel is rotated in the opening between the two uprights, a magnetic output can be withdrawn from the system by means of the leads coming from the third solenoid coil.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

FIG. 1 is a simplified perspective view of one version of the closed frame and first and second solenoids used in a prior art apparatus of the type used in the practice of the present invention.

FIG. 2 is a view similar to FIG. 1, but showing the typical wiring circuit of a prior art electromagnet.

FIG. 3 is a view similar to FIG. 1, but showing the addition of the third solenoid coil to the closed frame.

FIG. 4 is a view of the apparatus of FIG. 1 showing the addition of the uprights of the armature assembly which forms a part of the overall prior art assembly.

FIG. 5 is a simplified side view of the carousel which forms a part of the armature assembly.

FIG. 6 is a simplified, partly schematic view of the brush, contact and wiring assembly which operatively associates the carousel with the uprights of the closed frame.

FIG. 7 is an exploded view of the improved electromagnetic coil of the invention which can be used in the apparatus of FIG. 4.

FIG. 8 is a simplified, partly schematic view of the improved coil of the invention passing through the upright arms of the armature of the apparatus of FIG. 4.

### DETAILED DESCRIPTION OF THE INVENTION

The embodiments herein and the various features and advantageous details thereof are explained more fully with reference to the non-limiting embodiments that are illustrated in the accompanying drawings and detailed in the following description. Descriptions of well-known components and processes and manufacturing techniques are omitted so as to not unnecessarily obscure the embodiments herein. The examples used herein are intended merely to facilitate an understanding of ways in which the invention herein may be practiced and to further enable those of skill in the art to practice the embodiments herein. Accordingly, the examples should not be construed as limiting the scope of the claimed invention.

Applicant's invention provides an improved apparatus for generating an amplified magnetic output force. The primary features upon which the present invention relies are the use of what will be herein termed a “closed frame system” and a “closed circuit wiring system,” as well as a novel electromagnetic coil which will be described hereafter in greater detail. Applicant's “closed frame system” was described in the previously noted U.S. Pat. No. 7,759,809. The two basic components that make up the closed frame system are a solid iron or ferromagnetic frame and the two solenoids which are used to make the solid iron frame into an electromagnet. The principle components and operation of the system will be briefly described herein in order to more fully explain the advantages offered by Applicant's novel electromagnetic coil design.

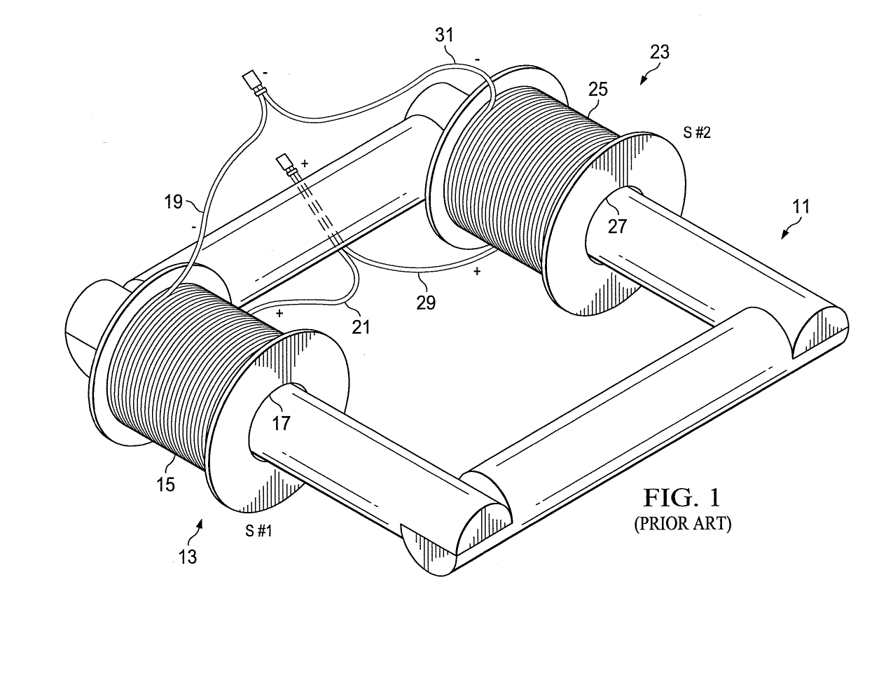

The preferred closed frame described in U.S. Pat. No. 7,759,809, is an iron or ferromagnetic frame that is either a solid piece of ferromagnetic material or individual pieces of ferromagnetic material welded, bolted, or otherwise constructed into the shape of a solid frame. This particular construction insures the “closed system of circulation” attributed to the ferromagnetic frame or base structure. While the particular embodiment of the frame 11 illustrated in FIG. 1 is a rectangle, it will be apparent from the discussion which follows that the frame could be of other polygonal shape, or could conceivably be round or oval.

In addition to the previously described closed frame, the prior art apparatus also incorporates a plurality of “solenoid coils.” For example, as shown in FIG. 1, a first solenoid coil 13 having a plurality of windings 15 and a central opening 17 is positioned on the frame 11. The first solenoid coil 13 is mounted on the closed frame 11 with the frame passing through the central opening 17. The first solenoid coil 13 has a first end or region 19 which comprises a magnetic-south, negative input and an opposed second end or region 21 which comprises a magnetic-north, positive output when energized. In a similar fashion, a second solenoid coil 23 is also positioned on the frame 11. The second solenoid coil 23 also has a plurality of windings 25 and a central opening 27. The second solenoid coil being 23 is mounted on the closed frame with the frame passing through the central opening 27. The second solenoid coil 23 has a first end or region 29 with a magnetic-north, positive input and an opposed second end or region 31 with a magnetic-south, negative output when energized.

As used in this discussion, the term “solenoid coil” is intended to mean a traditional current-carrying coil of wire that acts like a magnet when a current passes through it. The term “solenoid coil,” as used herein, is intended to distinguish the novel “electromagnetic coil” of the invention which has yet to be described in detail. The solenoid coils used in the practice of the present invention can conveniently each be a long coil of wire consisting of multiple loops. The coils may be comprised of any number of multiple turns using any gage of suitable wire in order to obtain the desired effects. For example, in one actual installation, the coils were comprised of 3000 turns of no. 28 copper wire.

It is a well known common law of physics that if an electrical current is run through a copper wire it naturally produces a magnetic field around the wire. In a straight segment of copper wire carrying an electrical current the magnetic field actually forms a cylindrically configured region around the wire that establishes itself by using the wire as its central axis of stabilization. When a segment of wire having an electrical current running through it is shaped into a circle or loop design it creates a natural magnetic field that physically circumscribes the wire loop. This naturally created magnetic field around the wire actually resembles a regular physical magnet. The end of the wire where the magnetic field enters the segment of wire acts as the South pole domain and the end where the magnetic force exits the segment of wire acts as the North pole domain.

The magnetic field strength of such a solenoid coil is the sum of the fields created by each individual loop, multiplied by the amperes of current running through the wire. Placing a piece of iron in the center of the solenoid creates an electromagnet. The iron greatly increases the magnetic strength of the solenoid because the individual domains in the iron become aligned by the magnetic field created by the current. Thus, the resulting magnetic field is the sum of the current running through the circular wire loops plus the magnetic field created by the aligned domains of the iron core.

As will be apparent in the discussion which follows, the present invention relates to sustaining the magnetic properties of an electromagnet where the ferromagnetic frame is closed and/or solid. More specifically, the present invention relates to sustaining the actual continual circulation of the magnetic force flowing through the electromagnet's ferromagnetic closed frame after the initial electrical power which has been used to “energize” the system has been removed.

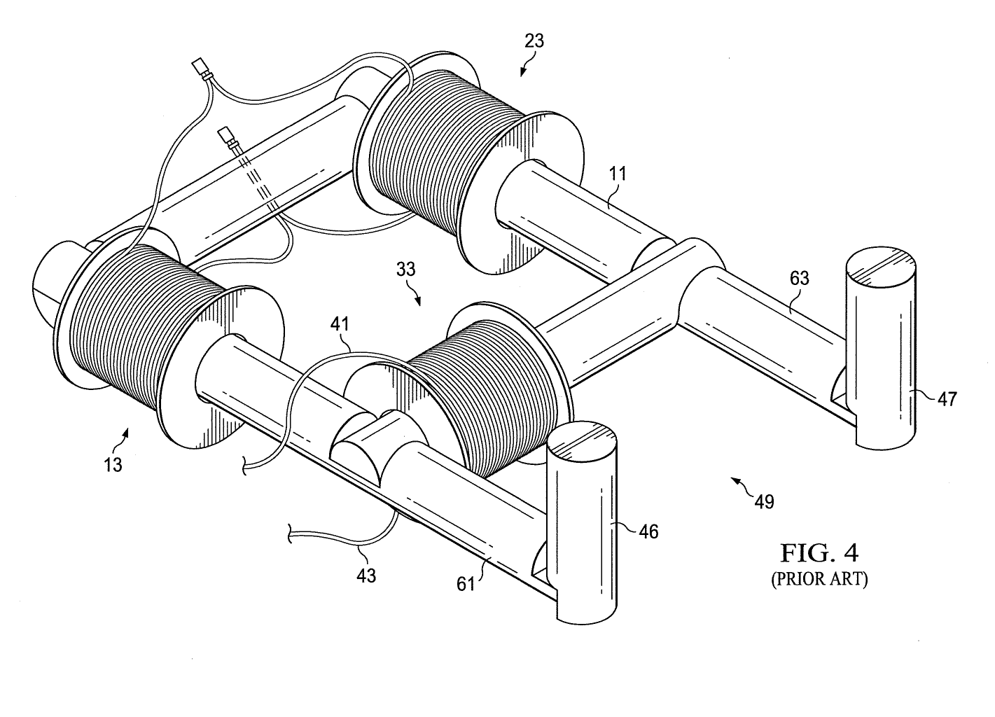

It will be apparent to those skilled in the relevant arts that the system shown in FIG. 4 utilizes a special wiring scheme to connect the various solenoids used in the system. The significance of the wiring scheme can best be explained in terms of certain fundamentals of solenoid designs. The design of the common solenoid coil is simple in nature, many loops of electrically conductive wire are tightly wound around a bobbin or spool frame. The frame is usually made from a nonconductive material such as brass or aluminum. The wire is layered onto the spool in a systematic fashion with the first row being laid at the bottom of the spool's frame closest to the center. Each layer of wire is then stacked one on top of the other until the appropriate number of loops have been added to the spool. As has been mentioned, the end of the wire where the magnetic field enters the segment of wire acts as the South pole domain and the end where the magnetic force exits the segment of wire acts as the North pole domain. The electrical power is normally initiated through this first row of loops closest to the center of the spool's frame. Thus, this end acts as the South pole domain of the solenoid and the exiting end of the wound spool naturally becomes the North pole of the solenoid.

An electromagnet normally is constructed with two solenoids, one on each leg or prongs of the horseshoe design.

It may be helpful to distinguish the specific wiring of the first and second solenoids which are used in the apparatus of FIG. 4 from the typical wiring of the two solenoids used in a standard electromagnet. When an electromagnet is powered from a standard DC battery the solenoids are attached so that the North pole magnets run closest to the center of one of the solenoids and the South pole magnets run closest to the center of the other solenoid. Thus, there are four electrical connections, one North pole and one South pole for each of the two solenoids. This equals out the amplification of each of the individual poles and makes the electromagnet as strong as it can be, in respect of the input of electrical power being supplied to the electromagnet.

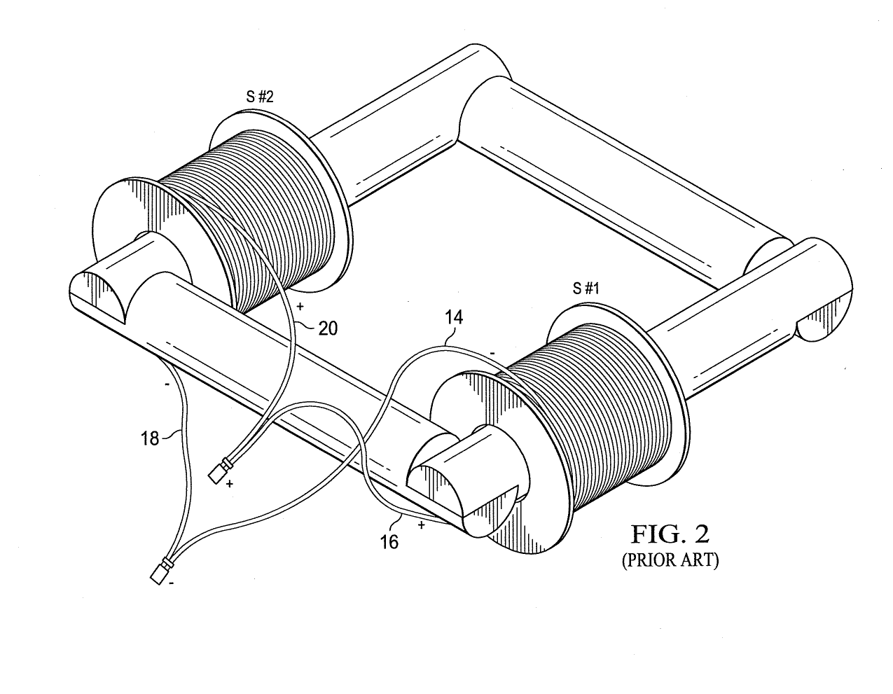

To provide a more specific example, with reference to FIG. 2 of the drawings, the wiring of a typical prior art electromagnet will now contrasted to the special wiring scheme utilized in the system described in FIG. 4. The two individual solenoids present in a typical electromagnet design are located on each of the two legs or prongs of the electromagnet and will be referred to as “S#1” and “S#2”, respectively (shown on Applicant's frame for purposes of comparison). Each of these solenoids “S#1” and “S#2” has two wires (14, 16 and 18, 20, respectively) protruding from them, one of these wires is always a North pole domain and one is always a South pole domain. For instance, the input wire 16 which is closest to the center of “S#1” is connected to the North or Positive pole of a standard DC battery. As a result, the input into “S#1” is consequently a North pole domain; which, based on the magnetic laws of physics, automatically creates a South pole domain coming out of the opposite end, i.e., the exit wire 14 of “S#1”. This exit wire of “S#1” is always connected to the South or Negative pole of the battery in order to fully saturate the solenoid with electrical power. However “S#2” is wired completely oppositely to that of “S#1”, meaning that the input wire 18 closest to the center of “S#2” is connected to the South or Negative pole of the DC battery making the input into “S#2” a South pole domain which, in turn, automatically makes the output wire 20 of “S#2” a North pole domain, each of the wire leads being connected to the DC battery in a fashion corresponding to its respective pole domain.

The wiring schematic of the first and second primary solenoid coils used in the system of FIGS. 1 and 4 can be seen to differ from that used for wiring a standard electromagnet, because the two individual solenoids are directly wired together so that they work as one. FIG. 1 provides a comparative example which can be used to explain the wiring of such a system. In the improved system, “S#1” and “S#2” are wired in a mariner which is exactly opposite to that previously described, i.e., “S#1” has a North or positive input 21 and a South or negative output 19 while “S#2” has a South or negative input 31 and a North or positive output 29, with each of the four wires connected to the DC battery in respect to its particular pole. In other words, Applicant's system features a wiring circuit connecting the first and second solenoid coils which are located on the closed frame, and wherein the input of the first solenoid coil is connected to the output of the second solenoid coil and the input of the second solenoid coil is connected to the output of the first solenoid coil, thereby forming a closed wiring circuit.

In actually wiring the apparatus, the DC battery is first disconnected completely. There are now four wires or leads extending from the two solenoid coils, two wires protrude from each of the two solenoid coils. The input wire of “S#1” which will maintain its North or positive pole domain is connected directly to the output wire of “S#2” which will also maintain its North or positive pole domain. In similar fashion, the input wire of “S#2” which will maintain its South or negative pole domain is now connected directly to the output wire of “S#1” which also maintain its South or negative pole domain.

At this point, Applicant wishes to make clear that at no point is it being claimed or suggested that more power could ever be extracted from a system than is being put into the system in some form. Applicant's inventive principles are consistent with known laws of physics including the law of “conservation of Mass-Energy” that states in simple terms that “the total energy in a closed or isolated system is constant, no matter what happens”. Also applicable is the law of “conservation of momentum”, which states in simple fashion that “the total momentum, in a closed system remains constant.”

Applicant's two individual solenoids used in the design shown in FIG. 1 do not work separately or independently as was the case in standard electromagnet design. They are actually wired together in such a way as to work together as one individual solenoid that creates a “closed system of circulation” between the two individual solenoid coils. Once the two solenoids are wired correctly they can then be charged. This can be conveniently accomplished through the use of, for example, a DC battery of some kind. The battery serves as a source of DC current initially connected in the wiring circuit in order to initially “energize” the apparatus. Preferably, the source of DC current is a battery having a positive terminal and a negative terminal, and wherein the input of the first solenoid coil is connected to the positive battery terminal and the output of the first solenoid coil is connected to the negative battery terminal, the second solenoid coil input and output being oppositely wired.

After charging for approximately an hour (when using a standard 12 volt car battery), the battery can be disconnected and the solenoids will stay “energized” to some extent. Initially charging the pair of solenoid coils, wired as previously described, creates the “closed system of circulation” of the solenoids themselves.

When these two individual “closed systems of circulation”, (the ferromagnetic frame and the double-solenoids) are combined into one individual machine and/or structured device they work together in synergistic fashion to maintain a consistent magnetic circulation within the ferromagnetic frame. This is a very basic design. The power of this system is equivalent to and is in direct proportion to the electrical power circulating within the double-solenoid or “closed system of circulation” design. This circulating magnet power will not vary in its intensity due to this particularly described “closed system of circulation” configuration that has been created between the ferromagnetic material and the double-solenoid design.

Two additional basic laws of physics may be considered to be employed in a design of this type. The first law is Newton's first law of motion, sometimes referred to as “the law of inertia” which states: “An object at rest tends to stay at rest and an object in motion tends to stay in motion with the same speed and in the same direction—unless acted upon by an unbalanced force.” The second law that may help to explain the theory of operation of the invention is Kirchhoff's first law or current law that specifically states that: “The algebraic sum of current into any junction is zero.” Since current is the flow of electrons through a conductor, it cannot build up at a junction, meaning that current is conserved: “what comes in must come out.” Both of these basic laws of physics have application in fully comprehending the reaction created using the wiring schematic of this particular specially form of electromagnet.

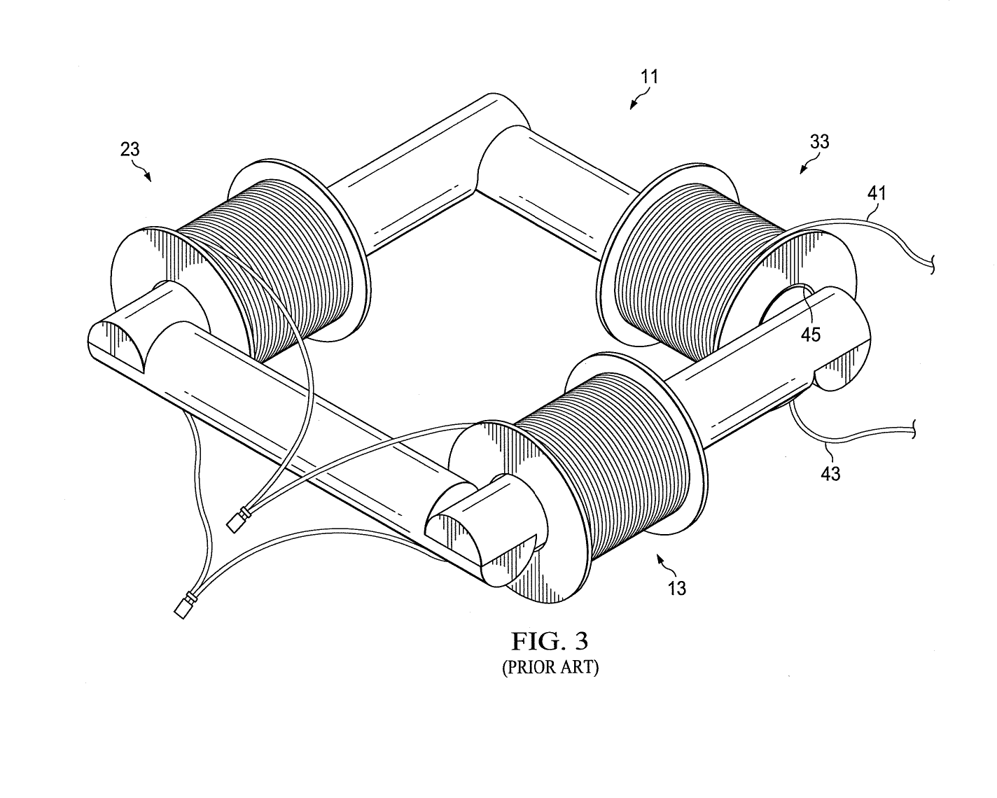

The described “closed system of circulation” also has connected thereto some sort of electromagnetic output device. For example, as shown in FIG. 3, the electromagnetic output device can be a third solenoid coil 33 having a plurality of windings terminating in a pair of output leads 41, 43 and a central opening 45, the third solenoid coil 33 being mounted on the closed frame 11 with the frame passing through the central opening 45. Such a third solenoid coil acts as an extraction attachment for the magnetic output within the “closed frame circuit” as explained above.

In other words, in the most basic design described above, the electrons or magnetic properties within the ferromagnetic structure are simply circulating within the “closed system” design. In order to extract the circulating electron or magnetic properties there has to be an opening of some kind which will allow this to be done “without” disrupting the “closed system” that has been stabilized. This can be accomplished by adding to the “closed system” already in place, a third solenoid (such as solenoid 33 in FIG. 3) which offers its two protruding wires 43, 45 as outlet ports or extraction ports. This third solenoid 33 also re-amplifies the already circulating electrons or magnetic properties trapped within the “closed system.”

Experiments show that adding this third solenoid has no special effect on the “closed system” by itself However, when a good strong neodymium magnet is brought into close proximity of any of the three solenoids 13, 23 and 33 and the magnet is then rotated at a reasonable RPM it causes the electron or magnetic properties of the “closed system” to exit the system by way of the two exit ports offered by the third solenoid 33 that has been added as described above.

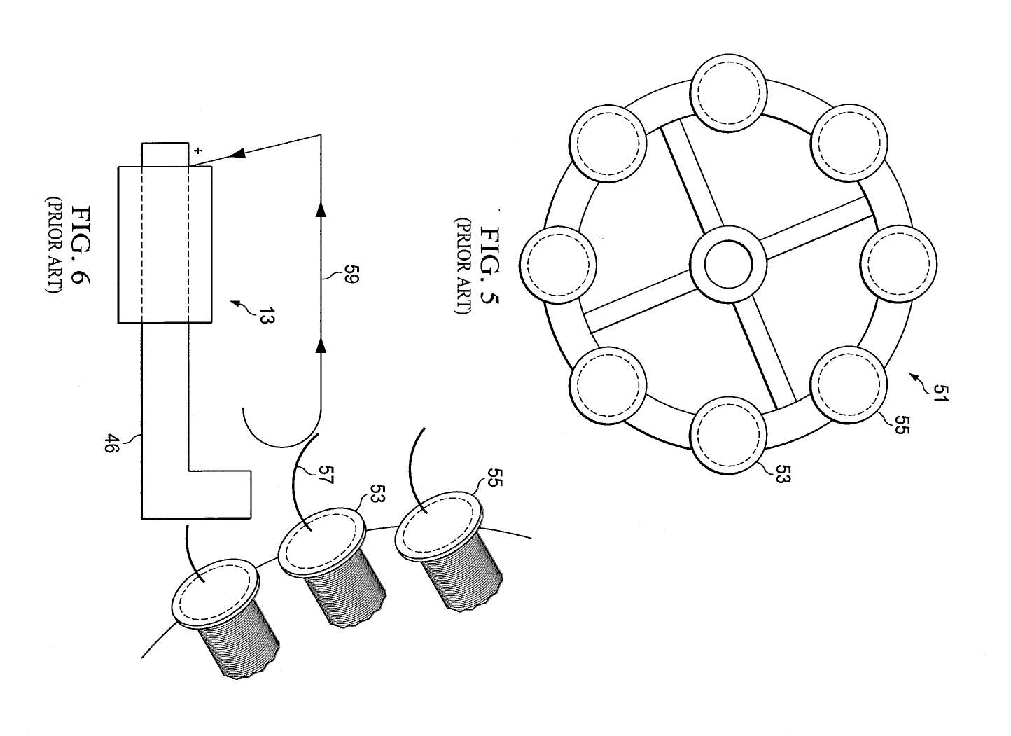

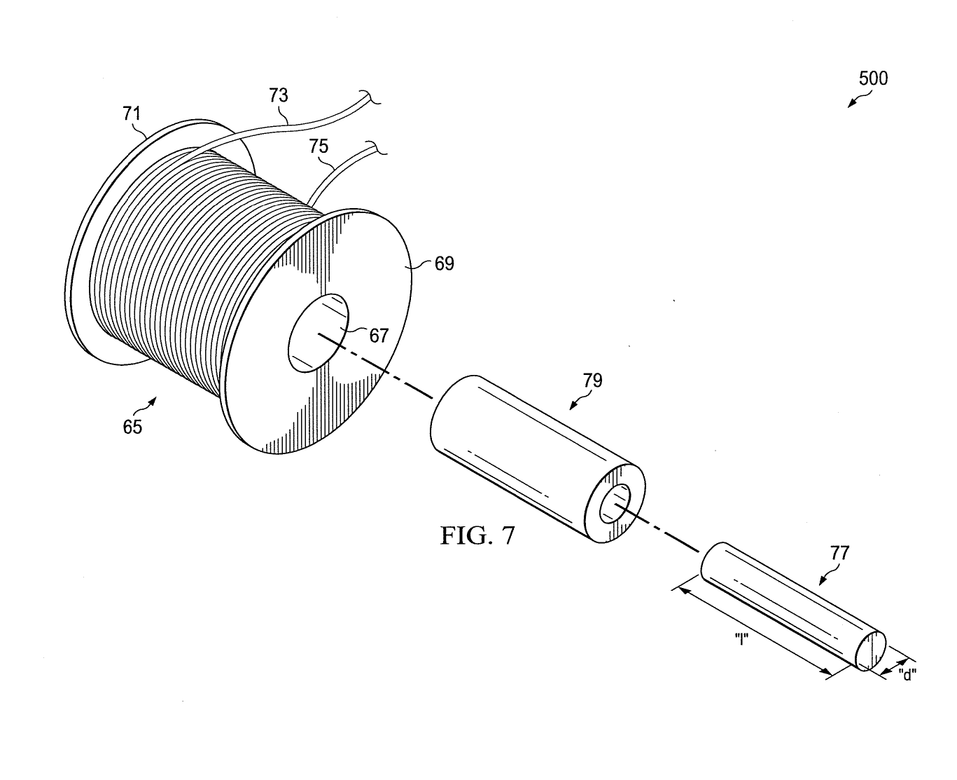

The previously described system also has added thereto what will be referred to herein as an “armature assembly”, the purpose of which is to mimic the function of the previously described neodymium magnet. The armature assembly, when operatively associated with the closed frame 11 and first, second and third solenoid coils (13, 23 and 33, respectively), supplies amplified power to the first and second solenoid coils, 13, 23. The armature assembly which is illustrated in FIG. 4 of the drawings includes a pair of uprights 46, 47 connected to the closed ferromagnetic frame 11 and separated by an opening 49. As illustrated in simplified fashion in FIGS. 5 and 6, a carousel 51 is arranged to pass through the opening 49 between the uprights 46, 47, the carousel having a plurality of additional (e.g. coils 53, 55, etc.) mounted thereon. In the particular implementation of the principles of the invention illustrated in FIG. 3, each of the coils mounted on the carousel has a contact surface or lead (57 in FIG. 6) which is arranged to contact a mating contact surface or lead 59 which is connected electrically to the first and second solenoid coils 13, 23 mounted on the closed frame 11.

The addition of the armature assembly must be accomplished while keeping the “closed system” of the invention completely intact. In order to accomplish this, modifications of the ferromagnetic frame are required. Thus, as has been explained with reference to FIG. 4, the frame 11 has been redesigned with the addition of the frame extensions 61, 63 and uprights 46, 47 in order to accommodate the structure of the “rotating wheel” or carousel 51; while at the same time keeping the “closed system” intact. However, once the wheel 51 is in proper position it replaces the power input of the rotating magnet with the amplified power input of multiple coils rotating at a better RPM and with a much higher magnitude of intensity.

FIG. 6 is a simplified, partly schematic view of a brush, contact and wiring assembly which operatively associates the carousel 51 with the uprights 46, 47 of the closed frame 11 and which illustrates one form of the amplification system which can be used with the previously described closed frame and closed wiring system of the invention. In FIG. 6, each of the rotating coils 53, 55 on the wheel or carousel 51 has a brush 57 which contacts an extraction point on the main apparatus, the extraction point in this case being a contact surface 59. As the wheel rotates, each coil's brush makes brief contact with the contact surface 59 provided on the main frame. The contact surface on the frame is electrically wired to, for example, the positive input of the illustrated solenoid 13 coil. Power can be extracted from the third solenoid coil (33 in FIG. 4) by means of the leads 41, 43 shown. The carousel wheel 51 can be rotated in any convenient manner. For example, an adjustable DC motor (not shown) could be used to operate the wheel, with its direct power input being drawn from the system.

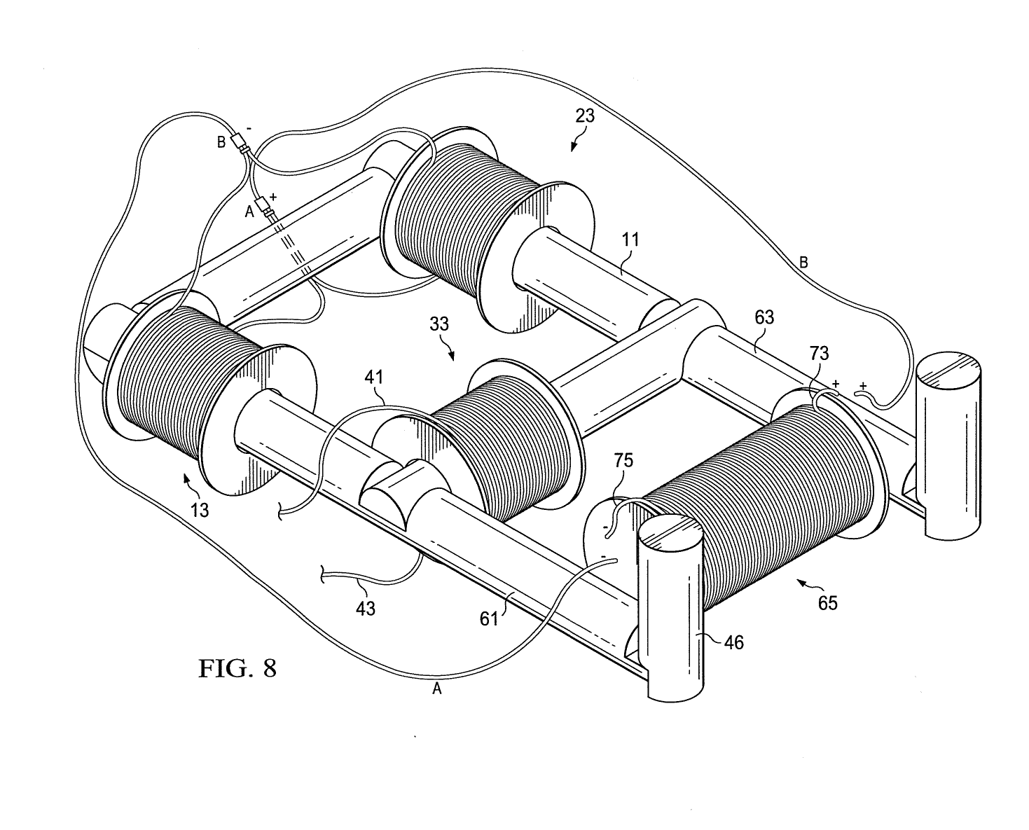

The system of the invention differs from the previously described system in using “electromagnetic coils” of a novel design which replace the prior art traditional solenoid coils carried on the carousel 51, With reference to FIG. 7, the novel electromagnetic coils of the invention include a plurality of helical windings (65 in FIG. 7) arranged about a central opening 67. In the example shown, the coils 65 are wound about a form or frame having a cylindrical mid section and opposing end plates 69, 71. The form or frame can conveniently be formed of a metal alloy, such as aluminum. The actual wire wrapped around the coil can be a precious metal such as gold wire, silver wire, platinum wire, or steel wire, or even iron wire such as is used in erecting electrical fences. Although any of a number of materials might be utilized for the helical windings, the windings can conveniently be comprised of a high tensile, drawn steel wire, such as a general purpose, high carbon steel, cold drawn wire having a diameter in the range from about 0.006 inch to 0.192 inch. In some cases, the wire may have a thin coating, such as a thin enamel coating applied thereto. The helical windings terminate in a first magnetic-north, positive lead 73 and a second magnetic-south negative lead 75.

In the case of the newly designed electromagnetic coil 65, it will be noted that the central opening 67 is designed to receive a core material 77. The core material can be of any substance such as a precious metal, e.g., gold or silver or platinum; or iron, or a crystal substance such as a gem stone or diamond, or even a natural substance such as wood or rock or even water. It will be thus appreciated that the core material can be made from a variety of materials. The core material can be selected to be whichever material the user prefers for the particular application at hand, since every substance known to man has a different quantity of electricity and magnetism that they are made of. In one preferred case of the invention, the core material 77 is a solid, non-ferrous, non-metallic core 77. Preferably, the core 77 is a rod-shaped, “rock” core. By the term “rock” is meant herein a relatively hard, naturally formed mineral or petrified matter; i.e., the solid mineral material forming part of the surface of the earth, exposed on the surface or underlying the soil or oceans. It could also encompass such diverse materials as the fossilized remains of aquatic life, i.e., dead carbonate type materials. The rod-shaped, rock core 77 has a given length “l” and a given diameter “d.” The rock core is selectively sized so as to be receive within and surrounded by a glass insulating cylinder (79 in FIG. 7) which runs for substantially the length “l” of the rock core.

While not wishing to be bound by the exact details of a specific example, one example electromagnetic coil used for experimental purposes was 6 inches in width between the end plates and 8 inches in diameter at the mid section and carried 1,500 turns of 0.0625 inch diameter wire. The central opening was approximately 2.5 inches in diameter and received a glass cylindrical tube which was 6 inches in length, ¼ inch thick, 2 inches in internal diameter and 2.5 inches in outer diameter. The core material was approximately 2 inches in outer diameter. There is space between the outer diameter of the glass tube and the 8 inch diameter aluminum frame holding the helical windings.

FIG. 8 is a simplified, partly schematic illustration of the improved electromagnetic coil 65 being used with the armature and solenoid coil system previously described with respect to FIG. 4. The coil 65 in FIG. 8 is shown in isolated fashion, it being understood that the coil would actually be mounted on the carousel shown as 51 in FIG. 5 and would rotate through the arms 46 of the armature arrangement in the manner previously described. The positive leads 73 and negative leads 75 would be arranged to contact the respective mating leads mounted on the frame 11 in any convenient manner, such as has been described previously with respect to FIG. 6 of the drawings.

The present invention provides several advantages. Without wishing to be bound by a particular theory, the magnetic output of the system is directly proportional to the material located within the glass tube 79 (the core material). Every substance has a different balance of electrons and protons that can be extracted from them. The electrical and magnetic properties extracted from any substance are proportional to the electrical and magnetic properties within the core. However, regardless of the material, the properties of electric and magnet output are always equal because in nature one is not found without the other. Electrical and magnetic properties are equally extracted at the same time. The filter (glass tube) separates the two into useable power. The combination of the closed wiring circuit and the closed frame structure result in the basic foundation of the magnetic circulation system design of the invention. The addition of a third solenoid coil to the closed frame provides a convenient extraction point, making it possible to extract the magnetic output from the basic closed circuit system, once additional power is made available. The new electromagnetic coil design can be used to provide a magnetic output from the system.

The uprights and carousel coil arrangement allows the individual electromagnetic coils on the carousel to be “energized” as they enter the electric/magnetic field which the armature arrangement produces. The armature arrangement makes it possible for the individual electromagnetic coils located on the rotating wheel to supply power to the two original solenoid coils located on the electromagnetic frame that work together as one component, giving the basic circulation system amplification each time an electromagnetic coil enters the field of the armature arrangement.

The interactions of each of the individually described areas noted above, all working in harmony with each other in order to insure and complete the circulation and energizing of the closed circuit system, thereby producing the properties necessary for the amplified generation of magnetic output from the system.

While the invention has been shown in only one of its forms, it is not thus limited but is susceptible to various changes and modifications without departing from the spirit thereof. For example, either the ferromagnetic frame or the solenoid wheel could be rotated relative to the other. Similarly, the carousel can be in a vertical position or in a horizontal position. The complete system can be of any size, depending upon the intended end application. Other variations will be apparent to those skilled in the art after studying the foregoing specification.

What is claimed is:

1. An improved electromagnetic coil for use in an apparatus for generating magnetic forces, the coil comprising:
a plurality of helical windings arranged about a central opening, the helical windings terminating in a first magnetic-north, positive lead and a second magnetic-south negative lead;
wherein the central opening contains a rod-shaped core material;
wherein the rod-shaped core material has a given length and a given diameter and wherein the core material is surrounded by and tightly received within a glass insulating cylinder which runs for substantially the length of the rod-shaped core within the central opening of the coil.

2. The improved coil of claim 1, wherein the core material is selected from the group consisting of precious metals, iron, crystal substances including gem stones, and natural materials including wood and rock.

3. The improved coil of claim 1, wherein the core material is a rod-shaped rock core.

4. The improved coil of claim 1, wherein the plurality of helical windings are comprised of a precious metal such as gold wire, silver wire, platinum wire, or a base metal such as steel wire and iron wire.

5. The improved coil of claim 1, wherein the plurality of helical windings are comprised of a high tensile, drawn steel wire.

6. The improved coil of claim 5, wherein the plurality of helical windings are comprised of a general purpose, high carbon steel, cold drawn wire having a diameter in the range from about 0.006 inch to 0.192 inch.

7. The improved coil of claim 6, wherein the wire has a thin enamel coating applied thereto.

8. An apparatus for generating magnetic forces, comprising:
a closed frame formed of a ferromagnetic material;
a first solenoid coil having a plurality of windings and a central opening, the first solenoid coil being mounted on the closed frame with the frame passing through the central opening, the first solenoid coil having a first end with a magnetic-north, positive input and an opposed second end with a magnetic-south, negative output when energized;
a second solenoid coil having a plurality of windings and a central opening, the second solenoid coil being mounted on the closed frame with the frame passing through the central opening, the second solenoid coil having a first end with a magnetic-south, negative input and an opposed second end with a magnetic-north, positive output when energized;
a wiring circuit connecting the first and second solenoid coils which are located on the closed frame, and wherein the input of the first solenoid coil is connected to the output of the second solenoid coil and the input of the second solenoid coil is connected to the output of the first solenoid coil, thereby forming a closed wiring circuit;
further comprising an electrical energy output device attached to the closed frame;
wherein the electrical energy output device is a third solenoid coil having a plurality of windings terminating in a pair of output leads and a central opening, the third solenoid coil being mounted on the closed frame with the frame passing through the central opening;
further comprising an armature assembly, operatively associated with the closed frame and first, second and third solenoid coils which supplies amplified power to the first and second solenoid coils;
wherein the armature assembly includes a pair of uprights connected to the closed ferromagnetic frame and separated by an opening, and a carousel which is arranged to pass through the opening between the uprights, the carousel having a plurality of electromagnetic coils mounted thereon;
wherein at least selected ones of the electromagnetic coils located on the carousel are comprised of a plurality of helical windings arranged about a central opening, the helical windings terminating in a first magnetic-north, positive lead and a second magnetic-south negative lead;
wherein the central opening contains a rod-shaped, rock core;
wherein the rod-shaped, rock core has a given length and a given diameter and wherein the rock core is surrounded by and tightly received within a glass insulating cylinder which runs for substantially the length of the rock core within the central opening of the coil.

9. The improved coil of claim 8, wherein the plurality of helical windings are comprised of a high tensile, drawn steel wire.

10. The improved solenoid coil of claim 9, wherein the plurality of helical windings are comprised of a general purpose, high carbon steel, cold drawn wire having a diameter in the range from about 0.006 inch to 0.192 inch.

11. The improved solenoid coil of claim 10, wherein the wire has a thin enamel coating applied thereto.

12. The apparatus of claim 11, wherein the electromagnetic coils mounted on the carousel each has a contact lead or surface which is arranged to contact a mating contact lead or surface which is connected to the first and second solenoid coils mounted on the closed frame.

13. A method of generating magnetic forces, the method comprising the steps of:
forming a closed frame from a ferromagnetic material;
providing a first solenoid coil having a plurality of windings and a central opening, the first solenoid coil being mounted on the closed frame with the frame passing through the central opening, the first solenoid coil having a first end with a magnetic-north, positive input and an opposed second end with a magnetic-south, negative output when energized;
providing a second solenoid coil having a plurality of windings and a central opening, the second solenoid coil being mounted on the closed frame with the frame passing through the central opening, the second solenoid coil having a first end with a magnetic-south, negative input and an opposed second end with a magnetic-north, positive output when energized;
wiring the first and second solenoid coils together in a wiring circuit, whereby the input of the first solenoid coil is connected to the output of the second solenoid coil and the input of the second solenoid coil is connected to the output of the first solenoid coil, thereby allowing the two solenoid coils to operate as one single closed solenoid circuit which assists in sustaining the circulation of electric/magnetic properties within the two solenoids;
wherein a source of DC current is initially connected in the closed solenoid wiring circuit in order to initially energize the first and second solenoid coils;
wherein the source of DC current is a battery having a positive terminal and a negative terminal, and wherein the input of the first solenoid coil is connected to the positive battery terminal and the output of the first solenoid coil is connected to the negative battery terminal, the second solenoid coil input and output being oppositely wired;
comprising the further step of attaching an output device to the closed ferromagnetic frame;
wherein the output device is a third solenoid coil having a plurality of windings terminating in a pair of output leads and a central opening, the third solenoid coil being mounted on the closed frame with the frame passing through the central opening;
further comprising the steps of operatively associating an armature assembly with the closed frame and first, second and third solenoid coils, the armature assembly being used to supply amplified power to the first and second solenoid coils which, in turn, communicate with the third solenoid coil for extraction through the output leads thereof;
wherein the armature assembly includes a pair of uprights connected to the closed ferromagnetic frame and separated by an opening therebetween, and a carousel which is arranged to pass through the opening between the uprights, the carousel having a plurality of electromagnetic coils mounted thereon;
wherein at least selected ones of the electromagnetic coils located on the carousel are comprised of a plurality of helical windings arranged about a central opening, the helical windings terminating in a first magnetic-north, positive lead and a second magnetic-south negative lead;
wherein the central opening contains a rod-shaped, rock core;
wherein the rod-shaped, rock core has a given length and a given diameter and wherein the rock core is surrounded by and tightly received within a glass insulating cylinder which runs for substantially the length of the rock core within the central opening of the coil; and
further comprising the step of extracting a magnetic force from the third solenoid coil located on the closed frame.

14. The method of claim 13, wherein the plurality of helical windings are comprised of a high tensile, drawn steel wire.

15. The method of claim 14, wherein the plurality of helical windings are comprised of a general purpose, high carbon steel, cold drawn wire having a diameter in the range from about 0.006 inch to 0.192 inch.

16. The method of claim 15, wherein the wire has a thin enamel coating applied thereto.
